(19) United States
(12) Patent Application Publication
(10) Pub. No.: US 2015/0261733 A1
(43) Pub. Date: Sep. 17, 2015

(54) ASSET COLLECTION SERVICE THROUGH CAPTURE OF CONTENT

(71) Applicant: Microsoft Corporation, Redmond, WA (US)

(72) Inventors: Ian Mikutel, Redmond, WA (US); Eleazar Vega-Gonzalez, Seattle, WA (US); Lee Riefberg, Redmond, WA (US); Srivatsa Srinivasan, Redmond, WA (US); Chris Caliz, Seattle, WA (US)

(73) Assignee: Microsoft Corporation, Redmond, WA (US)

(21) Appl. No.: 14/216,514

(22) Filed: Mar. 17, 2014

(51) Int. Cl. G06F 17/24; G06F 3/0484; G06F 17/22

(52) U.S. Cl. CPC G06F 17/24; G06F 17/2247; G06F 3/04842

(57) ABSTRACT

An asset collection service is provided through a capture of content provided by an external source. A capture management application detects a user selection to create the capture of a portion of the content. The capture is created from the portion by inserting a reference to an asset into the capture, where the asset is located within the portion. The asset is fetched from the external resource using the reference. Additionally, the reference is replaced with the fetched asset within the capture.

### BACKGROUND

A user may copy or “capture” information into a note or clipboard when browsing a web page. Capturing refers to collection of text, images or other content from a web page for future access (e.g., reading, annotating, collecting) when not actively browsing the web page or during an off-line session. A capture tool generally executes on a web browser at a client device to enable “capture” of content from a web page displayed from the web browser. In this context, capture refers to the extraction of the hypertext markup language (HTML), text and/or graphic elements from the web page to facilitate the storage of content.

A capture tool is usually associated with a specific destination application or storage. Functionality of a capture tool is often provided by a developer of the destination application as a plug-in or add-on for a web browser. A user is enabled to insert content from a web page easily into a document hosted by a client application when using the capture tool.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing an asset collection service through a capture of content. According to some example embodiments, a capture management application may detect a user selection to create a capture of a portion of content. The content may be displayed by a client application rendering the content of an external resource such as a browser rendering a web page hosted by a web server. The capture may be created from the portion. A reference to an asset may be inserted into the capture, where the asset is located within the portion. The asset may be determined to be above a predetermined file size threshold. Next, the asset may be fetched using the reference. Additionally, the reference in the capture may be replaced with the asset. In other example embodiments, a browser or other application/service based client may request a similar action.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example schema of a system to provide an asset collection service through a capture of content;

FIG. 2 illustrates an example of providing an asset collection service through a capture of content;

FIG. 3 illustrates example components of a system that provides an asset collection service through a capture of content;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of providing an asset collection service through a capture of content, according to embodiments.

### DETAILED DESCRIPTION

As briefly described above, a browser or similar application/service based client application may provide an asset collection service. A reference to an asset may be inserted into a capture, for example, a portion of displayed content. Upon detecting the request from the browser or client application, the reference may be replaced with the asset within the capture, after fetching the asset.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to provide an asset collection service through a capture of content. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

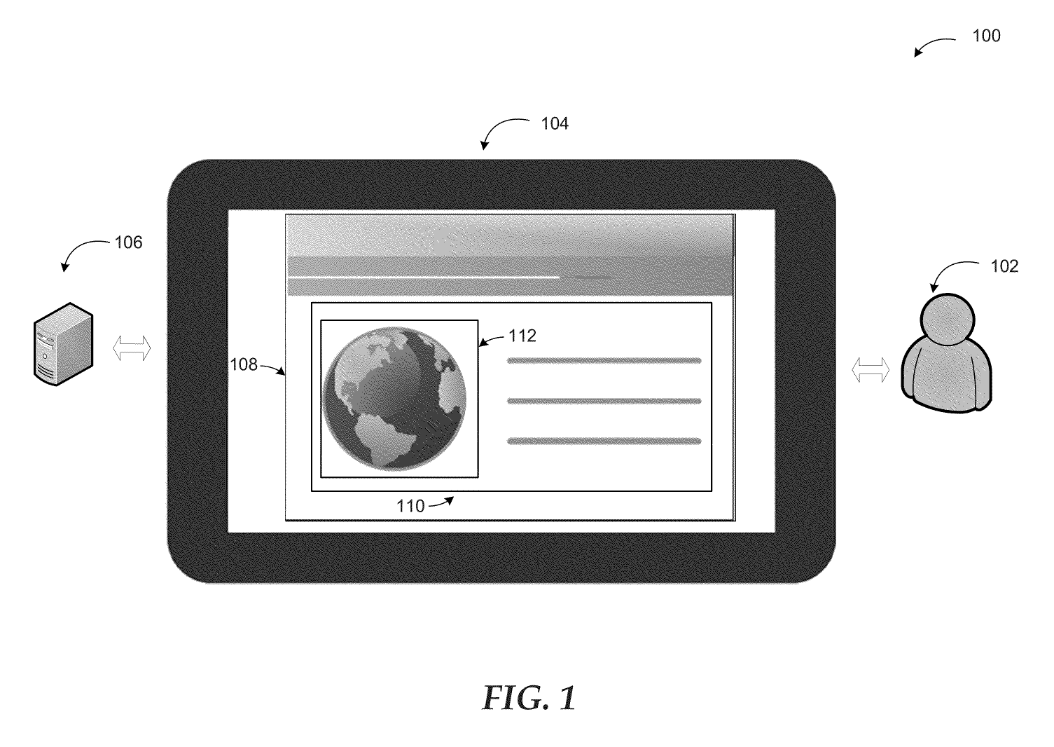

FIG. 1 illustrates an example schema of a system to provide an asset collection service through a capture of content, according to some embodiments herein. As illustrated in diagram 100, an asset 112 may be fetched, utilized, and stored while processing the capture 110.

According to some embodiments, an external resource such a server 106 may provide content for consumption. The server 106 may provide content such as documents, web pages, video clips, audio clips, and similar media for consumption by one or more applications executing in client devices or services provided by other servers. In an example scenario, a client device 104 may display content from the server 106 on a client application 108. The client application 108 may include a browser rendering a web page.

A user 102 may select a portion of the content rendered by the client application 108. The portion may be stored in a capture 110. The capture 110 may store the portion of the content as rendered by the client application 108. An example of the capture 110 may be a clipper that stores components of the portion including executable components.

Embodiments may provide an asset collection service through the capture of the content. A reference to an asset 112 may be inserted into the capture 110. An asset may include an image, a video clip, an audio clip, a document, and similar ones. A capture management application may retrieve the asset 112 from an external resource using the reference and insert the asset 112 into the capture 110. The asset 112 may be stored in a data store for future availability in a future capture of the content.

Embodiments are not limited to providing an asset collection service through the capture of the content. The capture management application may analyze content displayed by the client application 108 to determine assets within the content prior to detecting a user selection. The assets within the content may be fetched and stored in a data store or a local memory cache. One or more of the assets may be retrieved from the data store and inserted into the capture 110 in response to detecting the user selection of a portion of the content that includes the one or more assets.

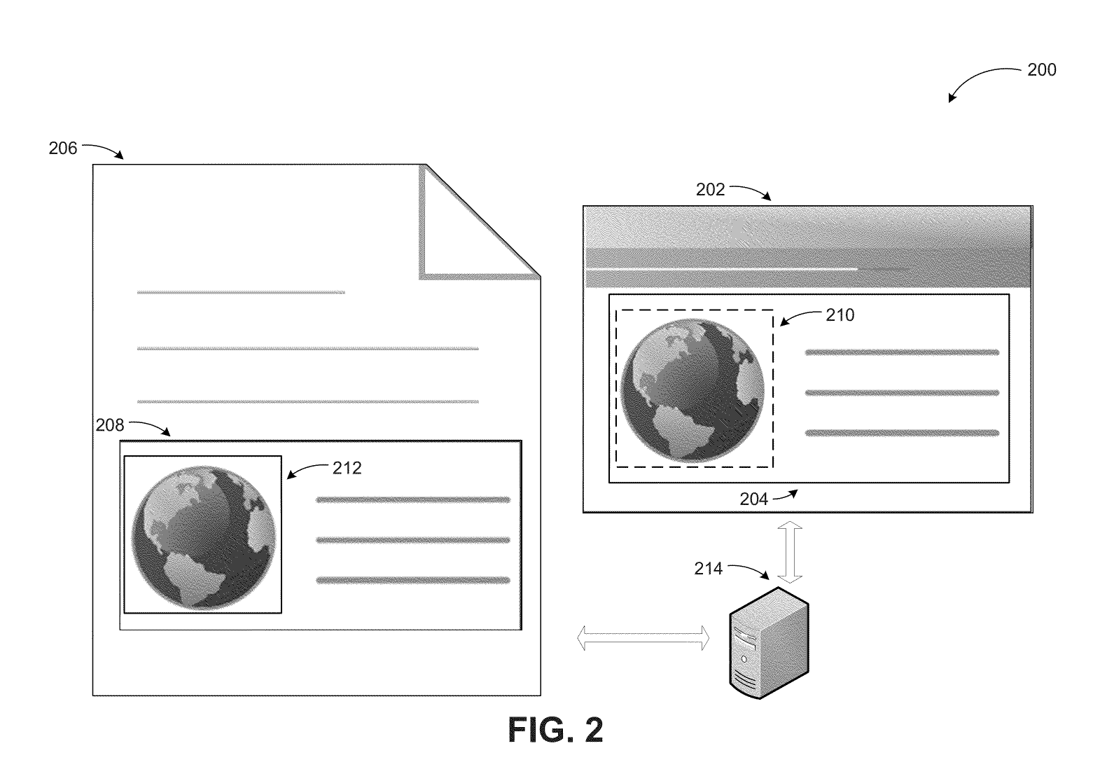

FIG. 2 illustrates an example of providing an asset collection through a capture of content, according to some embodiments herein. As illustrated in diagram 200, a reference 210 to an asset may be inserted into the capture 208 in response to a user selection to create the capture 208 from a portion 204 of the content displayed by client application 202.

In an example embodiment, a capture management application may detect the user selection to create the capture 208 from the portion 204 of the content displayed by a client application 202. A size of the asset within the portion 204 may be determined to be above a predetermined file size threshold. The predetermined file size threshold may be allowed to be configured manually by a user. Alternatively, the predetermined file size threshold may be dynamically configured based on a system attribute. The system attribute may include a memory capacity allocated to a process, a processing capacity allocated to a process, a storage capacity allocated to a process, and similar ones. The process may be associated with the asset. In addition, the asset within the portion 204 may also be determined to be stored by an external source 214.

The reference 210 to the asset stored by the external source 214 may be inserted into the capture 208. The reference may be determined to include a uniform resource identifier (URI) or a uniform resource locator (URL). Next, the capture management application may fetch the asset 212 from the external resource 214 using the reference 210 of the asset within the portion 204. The reference 210 may be used to locate the asset 212 stored by the external resource 214. An example of an external resource may include a web server, a third party content provider, and similar ones.

The asset 212 that is fetched from the external resource 214 may be used to replace the reference 210 within the capture 208. Next, the capture 208 may be inserted into an edit pane of a content application 206. The content application 206 may provide content management functionality to the user. In addition, the capture 208 and the asset 212 may be stored in a data store for availability in a future capture of the content displayed by the client application 202. The data store may be a local data store, a memory cache, or a trusted cloud based data store.

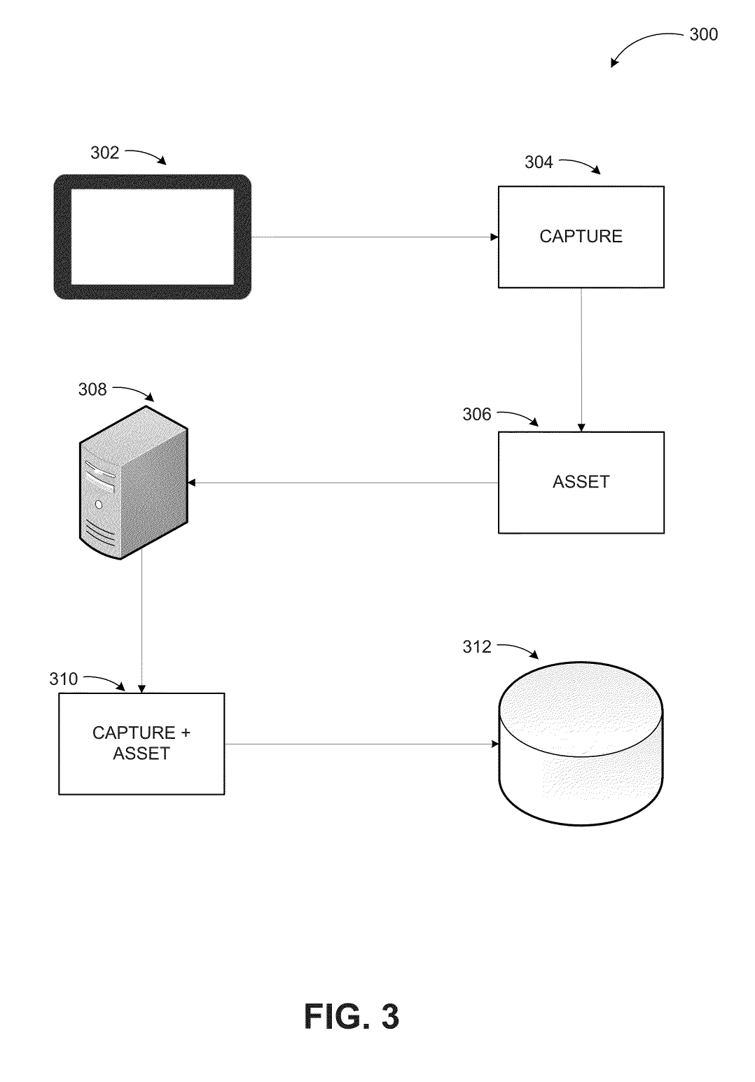

FIG. 3 illustrates example components of a system that provides an asset collection service through a capture of content, according to some example embodiments herein.

As illustrated in diagram 300, a capture management application executing on a server 308 may detect a user selection to create a capture 304. The capture 304 may be created from a portion of content displayed by a client device 302 through a client application rendering the content of an external resource. An example of the content may include a web page. An example of the external resource may include a web server.

The capture management application may determine an asset 306 within the portion of the content to be stored within the capture 304. A reference to the asset 306 may be inserted into the capture 304. An example of the reference may be a URI pointing to an image stored by the external resource, where the image is the asset 306.

Next, the asset 306 may be fetched from the external resource using the reference to locate the asset 306. A capture and asset 310 may be transmitted to a content application for insertion into content managed by the content application. The capture and asset 310 may also be stored in a data store 312 for a future capture.

In response to detecting another user selection of another portion of the content from the external resource, the capture management application may determine whether the other portion includes the asset 306. In response to determining the portion to include the asset 306, the capture management application may retrieve the asset 306 from the data store 312. The asset 306 may be inserted into to the future capture while creating the future capture from the other portion. The future capture may be transmitted to the content application based on a user action to insert the future capture into the content application.

Alternatively, the capture management application may detect a user selection that is substantially similar to the capture 304. The capture management application may retrieve the capture and asset 310 from the data store 312. The capture and asset 310 may be used to create a future capture. The future capture may be transmitted to the content application based on a user action to insert the future capture into the content application.

According to other embodiments, the capture management application may be executed by the server 308. The server 308 may be connected to the client device 302 through a local network. Alternatively, the server 308 may provide the asset collection service through a trusted connection within an external network.

The example applications, devices, and modules, depicted in FIGS. 1-3 are provided for illustration purposes only. Embodiments are not limited to providing of an asset collection service through a capture of content as shown in the example diagrams, and may be implemented using other engines, client applications, service providers, and modules employing the principles described herein.

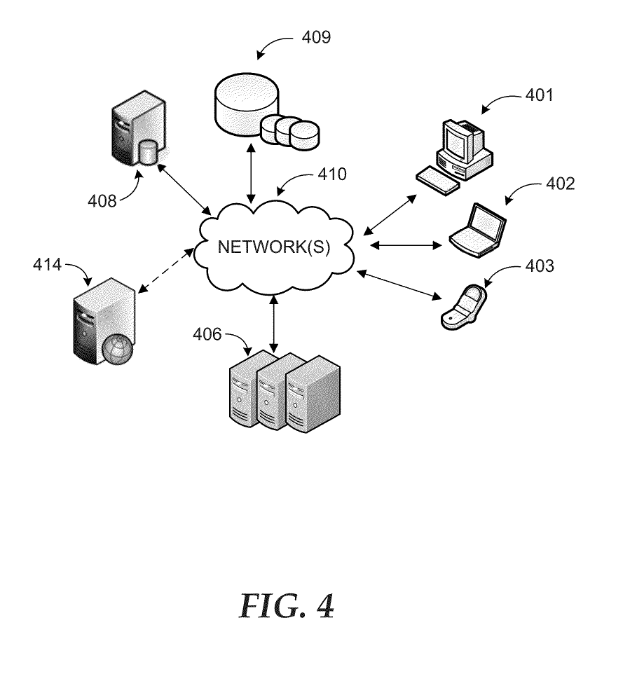

FIG. 4 is an example networked environment, where embodiments may be implemented. In addition to locally installed applications, a capture management application may also be employed in conjunction with hosted applications and services that may be implemented via software executed over one or more servers 406 or individual server 408. A hosted service or application may communicate with client applications on individual computing devices such as a handheld computer, a desktop computer 401, a laptop computer 402, a smart phone 403, a tablet computer (or slate), (‘client devices’) through network(s) 410 and control a user interface presented to users.

Client devices 401-403 are used to access the functionality provided by the hosted service or application. One or more of the servers 406 or server 408 may be used to provide an asset collection service through a capture of content. Relevant data may be stored in one or more data stores (e.g. data store 409), which may be managed by any one of the servers 406 or by database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to provide an asset collection service through a capture of content. Furthermore, the networked environments discussed in FIG. 4 are for illustration purposes only. Embodiments are not limited to the example applications, modules, or processes.

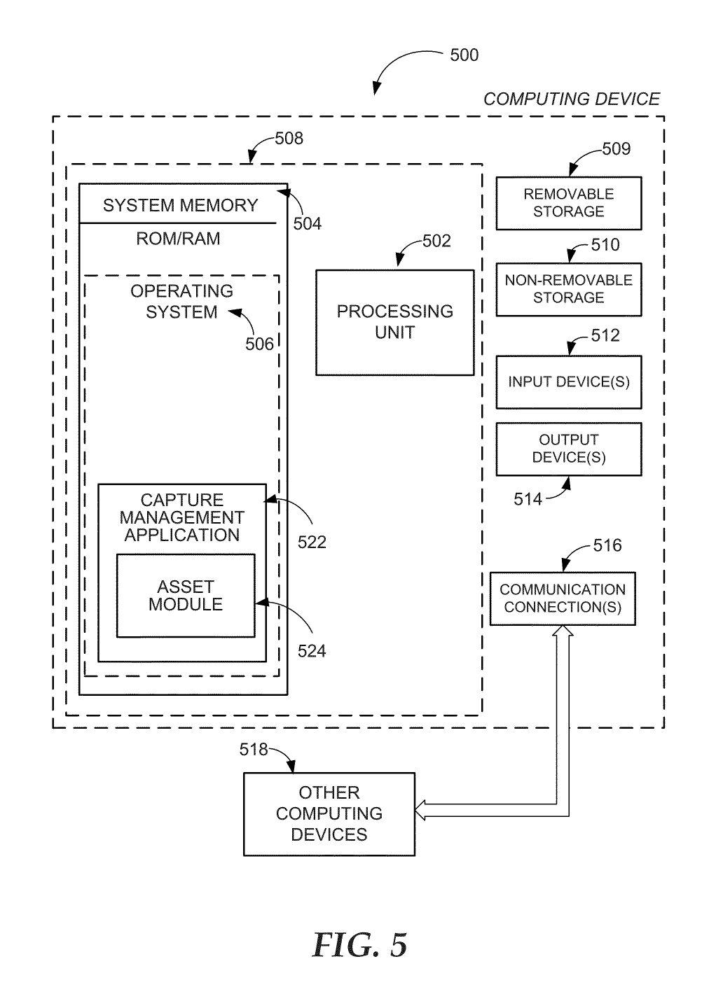

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any touch and/or gesture enabled device in stationary, mobile, or other form such as the example devices discussed in conjunction with FIGS. 1-3 and may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as a capture management application 522 and an asset module 524.

The asset module 524 may operate in conjunction with the operating system 506 or the capture management application 522 to provide an asset collection service through a capture of content. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 515 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

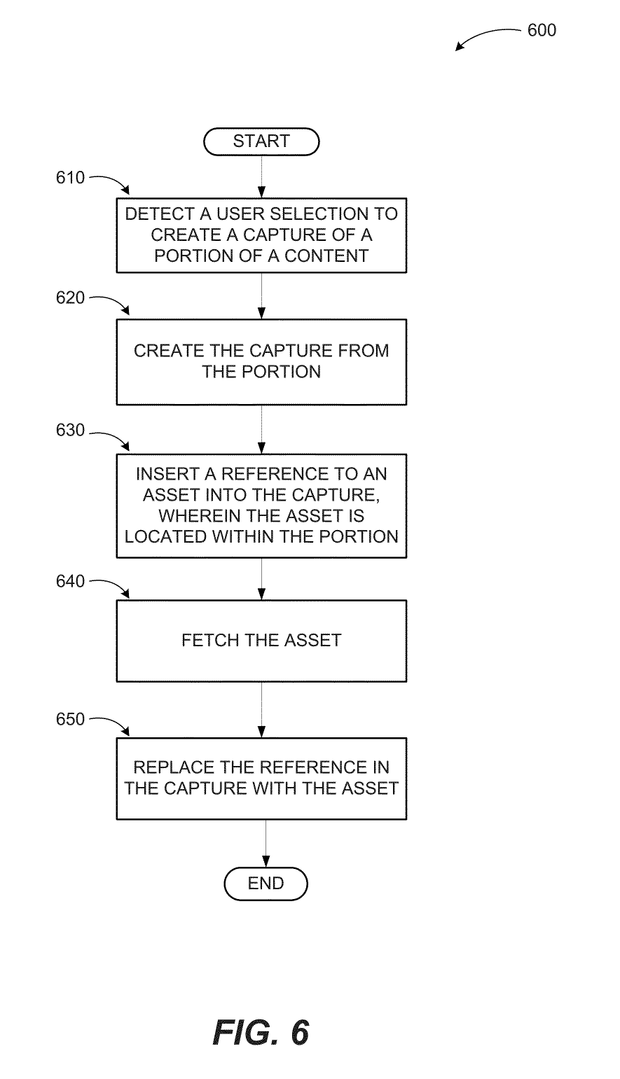

FIG. 6 illustrates a logic flow diagram for a process of providing an asset collection service through a capture of content, according to embodiments. Process 600 may be implemented as part of a capture management application or an operating system.

Process 600 begins with operation 610, “DETECT A USER SELECTION TO CREATE A CAPTURE OF A PORTION OF CONTENT,” where the content may be provided by an external resource such as a web server.

Operation 610 is followed by operation 620, “CREATE THE CAPTURE FROM THE PORTION,” where the capture may include components of the portion as rendered by a client application displaying the content.

Operation 620 is followed by operation 630, “INSERT A REFERENCE TO AN ASSET INTO THE CAPTURE, WHEREIN THE ASSET IS LOCATED WITHIN THE PORTION,” where the asset may include a media including one or more of an image, a video clip, an audio clip, a document, and similar ones.

Operation 630 is followed by operation 640, “FETCH THE ASSET,” where the asset may be located based on the reference within a third party provider storing the content.

Operation 640 is followed by operation 650, “REPLACE THE REFERENCE IN THE CAPTURE WITH THE ASSET.”

According to some embodiments, a method may be provided to provide an asset collection service through a capture of content. An example method may include detecting a user selection to create the capture of a portion of the content, creating the capture from the portion, inserting a reference to an asset into the capture, where the asset is located within the portion, fetching the asset, and replacing the reference in the capture with the asset.

According to other embodiments, the method may include storing the asset and the capture within a data store. The asset and the capture may be transmitted to one or more from a set of: a local data store, a memory cache, and a trusted external data store that serve as the data store to store the asset and the capture. The portion may be stored within the capture as rendered by a client application displaying the content from an external resource. Components of the portion may be stored within the capture including one or more from a set of: an executable script, an audio clip, a video clip, a document, a text, and an image.

According to further embodiments, the method may include locating the asset through the reference in an external resource that stores the asset. The reference may be determined to include a uniform resource identifier (URI). Alternatively, the reference may be determined to include a uniform resource locator (URL). The asset may be determined to include one or more from a set of: an image, a video clip, an audio clip, and a document. The asset may be fetched from an external resource including one or more from a set of: a web server and a third party content provider. The capture may be transmitted to a content application for insertion of the capture into an edit pane of the content application, based on a user input.

According to some embodiments, a server may be provided to provide an asset collection service through a capture of content. The server may include a memory and a processor coupled to the memory. The processor may execute a capture management application. The capture management application may be configured to detect a user selection to create the capture of a portion of the content, create the capture from the portion, insert a reference to an asset into the capture, where the asset is located within the portion, fetch the asset, replace the reference in the capture with the asset, and store the asset and the capture within a data store.

According to other embodiments, the capture management application may be further configured to determine a size of the asset to be above a predetermined file size threshold. A user may be allowed to manually configure the predetermined file size threshold. The predetermined file size threshold may be configured dynamically based on a system attribute including one or more from a set of: a memory capacity, a processing capacity, a storage capacity allocated to a process that is associated with the asset.

According to further embodiments, the capture management application may be further configured to detect another user selection to create a future capture from another portion of the content, where the other portion includes the asset, retrieve the asset from the data store, and create the future capture from the other portion by inserting the asset into the future capture.

According to other embodiments, the capture management application may be further configured to detect another user selection to create a future capture from another portion of the content, where the other portion is substantially similar to the portion, retrieve the capture and the asset from the data store, and create the future capture from the capture and the asset.

According to some embodiments, a computer-readable memory device with instructions to authenticate a clipper of content from a third party provider may be provided. The instructions may cause a method to be performed in response to execution, the method being similar to the methods described above.

The operations included in process 600 are for illustration purposes. Providing an asset collection service through a capture of content, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to provide an asset collection service through a capture of content, the method comprising:
detecting a selection to create the capture of a portion of the content;
creating the capture from the portion;
inserting a reference to an asset into the capture, wherein the asset is located within the portion;
fetching the asset; and
replacing the reference in the capture with the asset.

2. The method of claim 1, further comprising:
storing the asset and the capture in a data store.

3. The method of claim 2, wherein storing the asset and the capture in the data store comprises:
transmitting the asset and the capture to one or more from a set of: a local data store, a memory cache, or a trusted external data store.

4. The method of claim 1, further comprising:
storing the portion within the capture as rendered by a client application displaying the content from an external resource.

5. The method of claim 4, further comprising:
storing components of the portion within the capture including one or more from a set of: an executable script, an audio clip, a video clip, a document, a text, or an image.

6. The method of claim 1, further comprising:
locating the asset through the reference in an external resource that stores the asset.

7. The method of claim 6, further comprising:
determining the reference to include a uniform resource identifier (URI).

8. The method of claim 6, further comprising:
determining the reference to include a uniform resource locator (URL).

9. The method of claim 1, further comprising:
determining the asset to include one or more from a set of: an image, a video clip, an audio clip, or a document.

10. The method of claim 1, further comprising:
fetching the asset from an external resource including one or more from a set of: a web server or a third party content provider.

11. The method of claim 1, further comprising:
transmitting the capture to a content application for insertion of the capture into an edit pane of the content application.

12. A server to provide an asset collection service through a capture of content, the computing device comprising:
a memory;
a processor coupled to the memory, the processor executing a capture management application, wherein the capture management application is configured to:
detect a selection to create the capture of a portion of the content;
create the capture from the portion;
insert a reference to an asset into the capture, wherein the asset is located within the portion;
fetch the asset;
replace the reference in the capture with the asset; and
store the asset and the capture in a data store.

13. The server of claim 12, wherein the capture management application is further configured to:
determine a size of the asset to be above a predetermined file size threshold.

14. The server of claim 13, wherein the capture management application is further configured to:
allow manual configuration of the predetermined file size threshold.

15. The server of claim 13, wherein the capture management application is further configured to:
automatically configure the predetermined file size threshold dynamically based on a system attribute including one or more from a set of: a memory capacity, a processing capacity, a storage capacity allocated to a process that is associated with the asset.

16. The server of claim 12, wherein the capture management application is further configured to:
detect another selection to create a future capture from another portion of the content, wherein the other portion includes the asset;
retrieve the asset from the data store; and
create the future capture from the other portion by inserting the asset into the future capture.

17. The server of claim 12, wherein the capture management application is further configured to:
detect another selection to create a future capture from another portion of the content, wherein the other portion is substantially similar to the portion;
retrieve the capture and the asset from the data store; and
create the future capture from the capture and the asset.

18. A computer-readable memory device with instructions stored thereon to provide an asset collection service through a capture of content, the instructions including:
detecting a selection to create the capture of a portion of the content;
creating the capture from the portion;
inserting a reference to an asset into the capture, wherein the asset is located within the portion;
fetching the asset from an external resource including one or more from a set of: a web server or a third party content provider;
replacing the reference in the capture with the asset; and
storing the asset and the capture in a data store by transmitting the asset and the capture to one or more from a set of: a local data store, a memory cache, or a trusted external data store.

19. The computer-readable memory device of claim 18, wherein the instructions further comprise:
locating the asset through the reference in the external resource that stores the asset; and
determining the reference to include a uniform resource identifier (URI).

20. The computer-readable memory device of claim 18, wherein the instructions further comprise:
determining the asset to include one or more from a set of: an image, a video clip, an audio clip, and a document; and
transmitting the capture to a content application for insertion of the capture into an edit pane of the content application.
